(19) United States
(12) Patent Application Publication
(10) Pub. No.: US 2015/0184429 A1
(43) Pub. Date: Jul. 2, 2015

(54) LINKING-UP LOCK DEVICE FOR AUTOMATICALLY OPENING AND CLOSING ONE OR MORE LUGGAGE BOXES OF A MOTORCYCLE

(71) Applicant: CHIAO-PEN JUAN, New Taipei City (TW)

(72) Inventor: CHIAO-PEN JUAN, New Taipei City (TW)

(21) Appl. No.: 14/140,533

(22) Filed: Dec. 26, 2013

(51) Int. Cl. E05B 83/16; E05B 65/52; G07C 9/00; E05B 81/32; E05B 81/24; B62J 7/08; E05B 81/56

(52) U.S. Cl. CPC E05B 83/16; B62J 7/08; E05B 65/52; E05B 81/56; E05B 81/32; E05B 81/25; G07C 9/00158

(57) ABSTRACT

A linking-up lock device for automatically opening and closing one or more luggage boxes of a motorcycle includes at least one luggage box for motorcycle, at least one driver device, and at least one controller unit. The luggage box is provided with a cover that is opened and closed. The driver device connects and works with the luggage box and a driving part of the driver device is connected to the cover to make the cover move with the driving part. The controller unit links to and controls the driver device, making the cover open and close with the driving part of driver device that works. Accordingly, the luggage box is made to work without need of any hardware lock for easy use and prevention from burglars.

### BACKGROUND OF THE DISCLOSURE

### a) Technical Field of the Invention

This invention relates to a linking-up lock device for automatically opening and closing one or more luggage boxes of a motorcycle and particularly to the equivalent for vehicles.

### b) Description of the Prior Art

Having high mobility, motorcycles are widely used by the public, especially people who frequently travel out for business. Although the motorcycle is of facility, there are not many places for placement of articles on the motorcycle. Generally, a motorcycle as scooter has a space for receiving articles under its seat. Alternatively, there is a storage basket provided under the stem of the motorcycle for thereby storing articles in the storage space of the motorcycle for easy riding.

However, there are various types of motorcycles. Regarding a manual-transmission motorcycle and a motorcycle that may run on a high way, generally speaking, have no storage space for articles under their seats. Thus, the types of motorcycles must be equipped with an additional luggage box for storing articles.

However, this adscititious luggage box is provided with a lock to prevent the box from being opened by others, making the rider not worry about the security of storage of the articles in the box. Although the lock that is provided may prevent the box from being opened by others, if there are more than one luggage box installed on the motorcycle, the rider must have multiple keys, which thereby brings more trouble to the rider. Besides, currently designed luggage boxes are manual controlled and thus cannot be automatically controlled. Accordingly, it is apparent that improvement is necessarily made.

Consequently, because of the technical defects described above, to provide the a linking-up lock device for automatically opening and closing one or more luggage boxes of a motorcycle without need of any hardware lock, the applicant, based on many years of research and experience in the relevant industry has developed the present invention, which may effectively improve the defects described above.

### SUMMARY OF THE INVENTION

This invention is mainly to provide a linking-up lock device for automatically opening and closing one or more luggage boxes of a motorcycle without need of any hardware lock.

This invention is further to provide a user-friendly and burglarproof linking-up lock device for automatically opening and closing one or more luggage boxes of a motorcycle.

In order to achieve the object mentioned above, the linking-up lock device for automatically opening and closing one or more luggage boxes of a motorcycle according to this invention comprises at least one luggage box for motorcycle, at least one driver device, and at least one controller unit. The luggage box is provided with a cover that is opened and closed. The driver device connects and works with the luggage box and a driving part of the driver device is connected to the cover to make the cover move with the driving part. The controller unit links to and controls the driver device, making the cover open and close with the driving part of driver device that works. Accordingly, the linking-up lock device for automatically opening and closing one or more luggage boxes of motorcycle that is made to work without need of any hardware lock is easily used for prevention from burglars.

In the linking-up lock device for automatically opening and closing one or more luggage boxes of a motorcycle, the driver device is provided inside or outside the luggage box to work with.

In the linking-up lock device for automatically opening and closing one or more luggage boxes of a motorcycle, the driver device is a driving motor, an oil pressure cylinder, a hydraulic pressure cylinder, an air pressure cylinder, a mechanical linkage, or a gear.

In the linking-up lock device for automatically opening and closing one or more luggage boxes of a motorcycle, the control unit is wired or wireless connected to one or more driver devices.

In the linking-up lock device for automatically opening and closing one or more luggage boxes of a motorcycle, the control unit is a fingerprint sensor or a palm-print sensor.

In the linking-up lock device for automatically opening and closing one or more luggage boxes of a motorcycle, an alarm that alarms when the cover is opened is provided between the luggage box and the cover.

In the linking-up lock device for automatically opening and closing one or more luggage boxes of a motorcycle, the controller unit is further provided with an anti-interrupt power-off button.

Compared with the prior art, the linking-up lock device according to this invention has the following advantages:
1. With the driver device that directly drives the luggage box to open and close, easy operation is achieved; and
2. with the driver device, the linking-up lock device that is made to work without need of any hardware lock is easily used for prevention from burglars. In order to further know the features and technical means of this invention, refer to the detailed description below according to this invention accompanied with drawings; however, the accompanied drawings are provided for reference and illustration only and are not limited to this invention.

### BRIEF DESCRIPTION OF THE DRAWINGS

FIG. 1 is a 3D view of a first embodiment of this invention.

FIG. 2 is an exploded view of the first embodiment of this invention.

FIG. 3 is a schematic view illustrating an operation state of the first embodiment of this invention.

FIG. 4 is a 3D view of a second embodiment of this invention.

FIG. 5 is a schematic view illustrating an operation state of the second embodiment of this invention.

FIG. 6 is a schematic view illustrating an operation state of a third embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

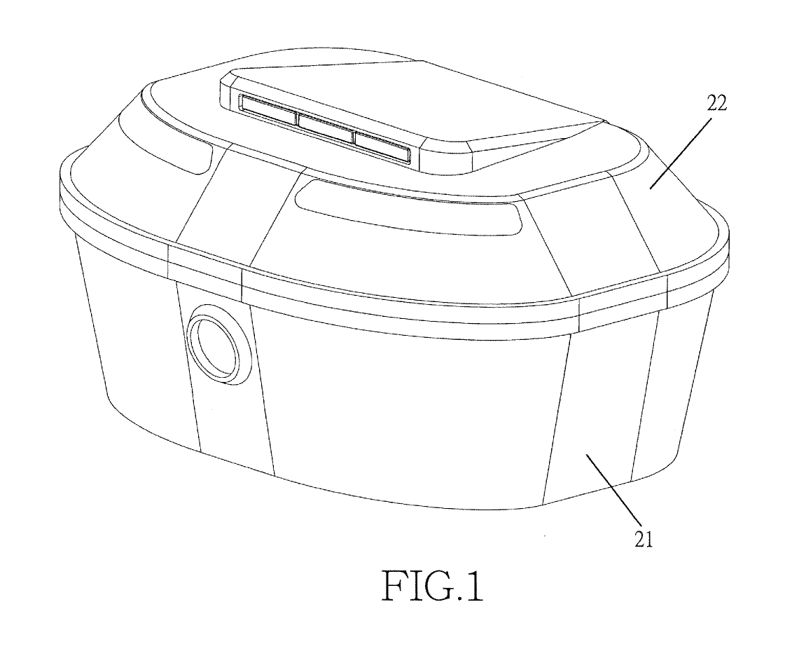

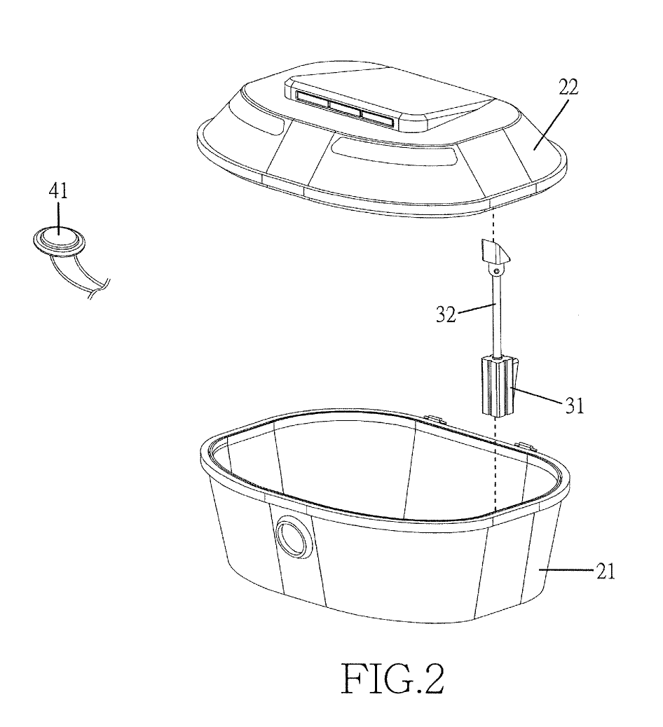

Refer to FIGS. 1, 2 and 3. A linking-up lock device for automatically opening and closing one or more luggage boxes of a motorcycle according to this invention comprises at least one luggage box 21 for motorcycle, at least one driver device 31, and at least one controller unit 41. The luggage box 21 according to this invention is provided under a seat 11 of a motorcycle 1. The top of luggage box 21 is not shielded, of which one side is movably pivoted to a cover 22. The driver device 31 is provided inside the luggage box 21. A driving part 32 of the driver device 31 is connected to the cover 22 to make the cover 22 move with the driving part 32. The driver device 31 is a driving motor, an oil pressure cylinder, a hydraulic pressure cylinder, an air pressure cylinder, a mechanical linkage, or a gear. In this embodiment, the driver device 31 is an oil pressure cylinder. The controller unit makes a wired or wireless connection to and controls the driver device 31. In this embodiment, the control unit is a control button 41.

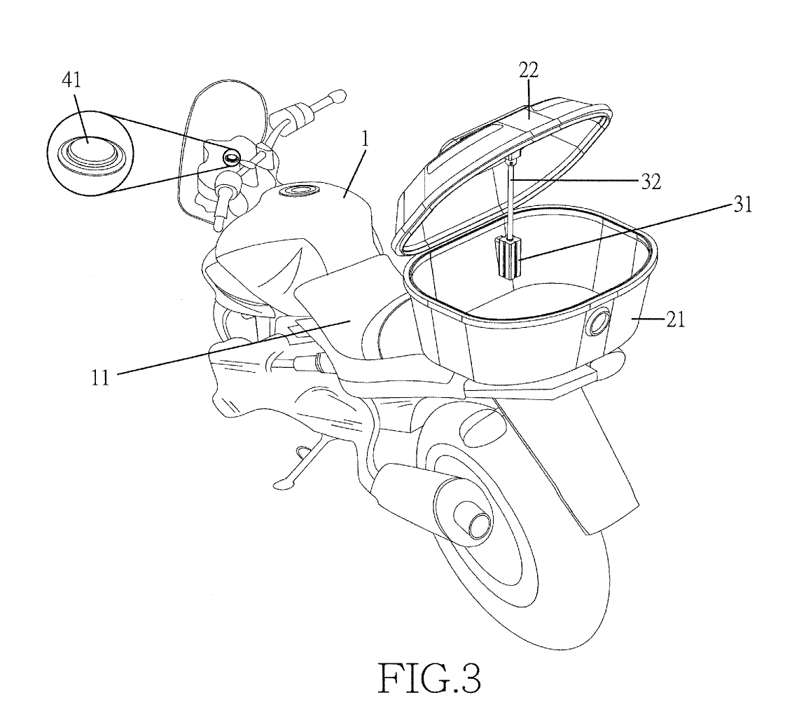

Refer to FIG. 3 again. The luggage box 21 is provided under the seat 11 of the motorcycle 1. The control button 41 is provided on a proper section of a panel of the stem. Thus, with the control button 41, the driving part 32 of the driver device 31 is made to activate an oil pressure rod of the oil pressure cylinder, thereby making the cover 22 not to be driven, by the driving part 32, with the side pivoted to the luggage box 21. When all articles are placed, the control button 41 is controlled again to activate the driving part 32 of the driver device 31, making the cover 22 to be driven by the driving part 32 and closed.

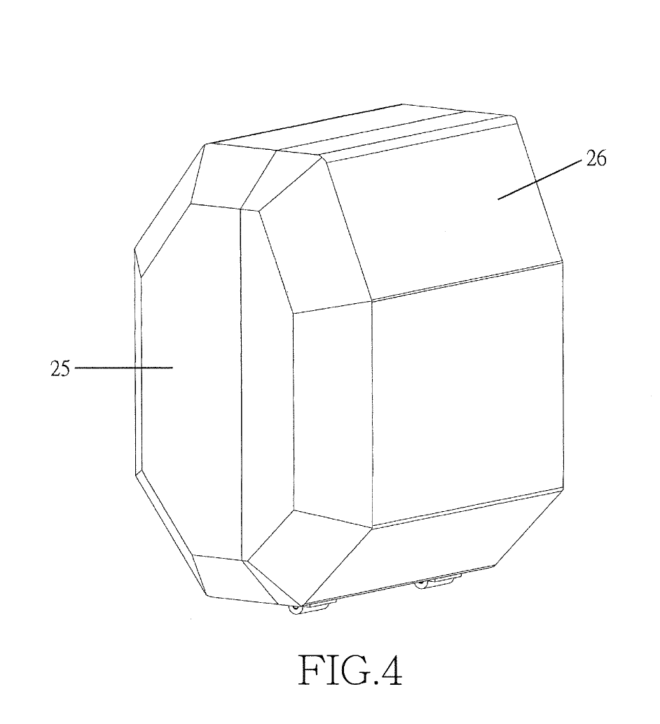

With reference to FIG. 4 illustrating a second embodiment of this invention, the linking-up lock device for automatically opening and closing one or more luggage boxes of the motorcycle comprises at least one luggage box for motorcycle, at least one driver device 35, and at least one controller unit. The luggage boxes in this embodiment of this invention are provided at left and right sides of the seat 11 of the motorcycle 1. The lateral side of luggage box 25 is open, of which the bottom of open side of the luggage box 25 is movably pivoted to a cover 26. The driver device 35 is provided inside the luggage box 25. A driving part 36 of the driver device 35 is connected to the cover 26 to make the cover 26 move with the driving part 36. The controller unit makes a wired or wireless connection to and controls the driver device 35. In this embodiment, the control unit is a control button 42.

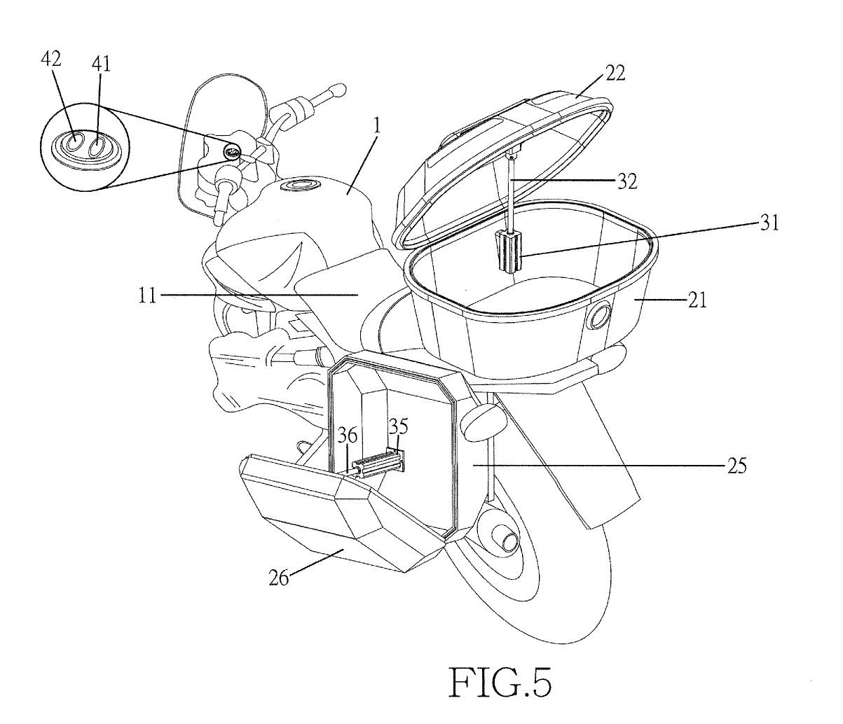

Refer to FIG. 5. The luggage box 21 is provided at a rear area of the seat 11 of the motorcycle 1, while the other luggage box 25 is provided at the left and right sides of the seat 11 of the motorcycle 1. The control buttons 41 and 42 of the control unit are electrically connected to the lock on the stem. The control buttons 41 and 42 are provided on the proper section of the panel of the stem. With the control buttons 41 and 42, the driving parts 32 and 36 of the driver devices 31 and 35 are driven, thereby making the covers 22 and 26 not to be driven, by the driving parts 32 and 36, with the side pivoted to the luggage boxes 21 and 25. When all articles are placed, the control buttons 41 and 42 are controlled again to activate the driving parts 32 and 36 of the driver devices 31 and 35, making the covers 22 and 26 to be driven by the driving parts 32 and 36 and closed. Further, the driving parts 32 and 36 of the driver devices 31 and 35 may be controlled respectively by the two control buttons 41 and 42 and may also be controlled together by a single button.

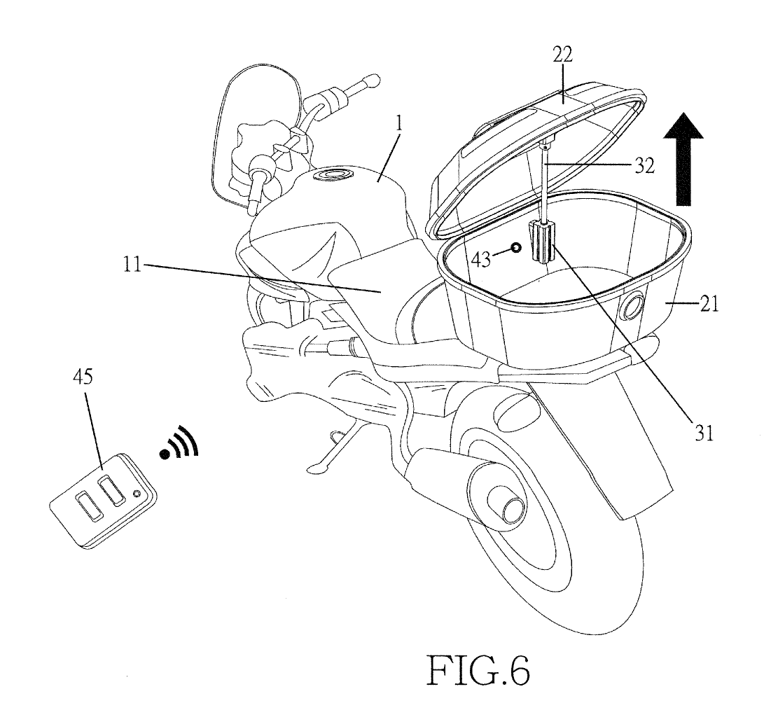

Refer to FIG. 6. Inside the rear luggage box 21 connecting and working with the seat 11 of the motorcycle 1, the driving part 32 of the driver device 31 is connected to the cover 22 to make the cover 22 move with the driving part 32. The control unit connected to the driver device 31 makes a wireless connection to and controls the driver device 31. The controller units in this embodiment are a wireless signal receiver 43 and a wireless signal transmitter 45. Further, to avoid from being interrupted by a strange wireless signal, the controller unit is further provided with an anti-interrupt power-off button, thereby preventing the luggage box 21 from being opened without reason. An alarm that alarms when the cover 22 is opened may further be provided between the luggage box 21 and the cover 22. The control unit may be also a fingerprint sensor or a palm-print sensor.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A linking-up lock device for automatically opening and closing one or more luggage boxes of a motorcycle, comprising:
at least one luggage box for motorcycle, being provided with a cover that is opened and closed;
at least one driver device, connecting and working with the luggage box, of which a driving part is connected to the cover to make the cover move with the driving part; and
at least one controller unit, linking to and controlling the driver device, making the cover open and close with the driving part of driver device that works and further making the luggage box work without need of any hardware lock for easy use and prevention from burglars.

2. The linking-up lock device for automatically opening and closing one or more luggage boxes of the motorcycle according to claim 1, wherein the driver device is provided inside or outside the luggage box to work with.

3. The linking-up lock device for automatically opening and closing one or more luggage boxes of the motorcycle according to claim 1, wherein the driver device is one of a driving motor, an oil pressure cylinder, a hydraulic pressure cylinder, an air pressure cylinder, a mechanical linkage, and a gear.

4. The linking-up lock device for automatically opening and closing one or more luggage boxes of the motorcycle according to claim 1, wherein the control unit is wired or wireless connected to one or more driver devices for control.

5. The linking-up lock device for automatically opening and closing one or more luggage boxes of the motorcycle according to claim 1, wherein the control unit is one of a fingerprint sensor and a palm-print sensor.

6. The linking-up lock device for automatically opening and closing one or more luggage boxes of the motorcycle according to claim 1, wherein an alarm that alarms when the cover is opened is provided between the luggage box and the cover.

7. The linking-up lock device for automatically opening and closing one or more luggage boxes of the motorcycle according to claim 1, wherein the controller unit is further provided with an anti-interrupt power-off button.
